(19) United States
(12) Patent Application Publication
(10) Pub. No.: US 2007/0168583 A1
(43) Pub. Date: Jul. 19, 2007

(54) ENDPOINT CONTROL APPARATUS AND METHOD THEREOF

(76) Inventor: Won-Tae Kim, Seoul (KR)

Correspondence Address: Frank Chau, Esq.;F. CHAU & ASSOCIATES, LLC, 130 Woodbury Road, Woodury, NY, 11797, US

(21) Appl. No.: 11/558,153

(22) Filed: Nov. 9, 2006

(30) Foreign Application Priority Data
Jan. 19, 2006 (KR) 2006-05945

(51) Int. Cl. G06F 3/00; G06F 5/00

(52) U.S. Cl. 710/56; 710/57

(57) ABSTRACT

An endpoint control apparatus for a device communicating between a host and plural endpoints by way of a universal serial bus includes pluralities of buffers corresponding to the plural endpoints, a first storage unit having data storage status information of the buffers, a controller allocating an empty one of the buffers to a selected one of the endpoints in response to the data storage status information, and a second storage unit having a result of the buffer allocation.

### CROSS-REFERENCE TO RELATED APPLICATION

This U.S. non-provisional patent application claims priority under 35 U.S.C. § 119 of Korean Patent Application No. 2006-05945 filed on Jan. 19, 2006, the entire contents of which are hearby incorporated by reference.

### BACKGROUND

The present disclosure relates to universal serial bus (USB) system. In particular, the disclosure herein relates to an endpoint control apparatus and method for a USB system.

USB is typically an industrial standard for connecting a host with a peripheral device, for example, keyboard, mouse, web camera, joystick, or storage. Since a USB is able to provide a function of plug-and-play for the peripheral device, there is no need of preparing a set switch or jumper, installing an exclusive card, or altering a system corresponding thereto. Owing to the benefits of the USB, such as user's facility, low price, and excellent performance, it is widely used in a variety of host devices.

In the use of a USB, a host can be connected with 127 USB devices each of which may have 16 endpoints at a maximum. That is, it is permissible for a single USB device to embed 16 functions therein. A USB system is provided with an independent channel, which is referred to as a pipe, for linking host with an endpoint of the USB device. Each such endpoint is associated with a first-in/first-out (FIFO) memory, in a given size, for transceiving data with the host. The FIFO memory functions as a buffer storing data transceived between the host and the endpoint.

Most bus transactions carried out in the USB system begin with sending packets, so-called ‘token packets’, containing types and directions of the transactions, USB device addresses, and endpoint numbers. In the transaction, data transmission proceeds toward the host from the USB device, referred to as ‘IN’ direction, or toward the USB device from the host, referred to as ‘OUT’ direction. The host or USB device receiving the data responds thereto by means of a handshake packet. The type of the handshake packet, for example, ACK, informs of normal data reception, while the other type of the handshake packet, for example, NAK, informs that there is an error in receiving data or that data has not arrived.

As is well known, since the USB is in accordance with the communication standard for serial communication, it is just able to write/read data in/from only a single FIFO memory at a time. Thus, when a processing speed for data transceived in the IN/OUT direction is insufficient, the USB device sends a NAK response, that is, a NAK handshake packet, to the host. Upon receiving the NAK response, the host re-transmits the packet to the USB device after a predetermined time. Nevertheless, too frequent NAK responses will degrade the transceiving rate of the data in the USB system. Therefore, there have been proposed some solutions for overcoming such degradation of the transceiving rate, for example, raising a system clock frequency of the USB device, or enlarging a size of the HIFO memory. As the system clock frequency is proportional to power consumption thereof, however, that solution is not applicable to a potable USB device that must expend small amounts of power. Moreover, enlarging the size of the FIFO memory would inevitably increase the whole chip size.

### SUMMARY OF THE INVENTION

Exemplary embodiments of the present invention are directed to solve the aforementioned problems, by providing an endpoint control apparatus and method capable of improving data transceiving efficiency without increasing power consumption or increasing chip size in a USB system.

An exemplary embodiment of the present invention provides an endpoint control apparatus for a device communicating between a host and plural endpoints by way of a universal serial bus, comprising: pluralities or buffers corresponding to the plural endpoints; a first storage unit having data storage status information of the buffers; a controller allocating an empty one of the buffers to a selected one of the endpoints in response to the data storage status information; and a second storage unit having a result of the buffer allocation.

In this exemplary embodiment, the buffer is a first-in/first-out (FIFO) memory and the data storage status information represents whether each buffer is empty.

In this exemplary embodiment, the first storage unit includes a status transfer register informing of the number of data stored in each buffer and the second storage unit has logical and physical addresses of the buffer allocated to the selected endpoint.

In this exemplary embodiment, the buffer allocation result is stored in one of the mapping table and the pointer forms and the buffers are the same as each other in memory size.

In this exemplary embodiment, the buffers store data in a unit equal to or smaller than the maximum packet size.

In this exemplary embodiment, the controller allocates the buffer to make each endpoint receive more than one data.

According to an exemplary embodiment of the present invention, a method of controlling endpoints for a device communicating between a host and the endpoints by way of a universal serial bus in comprised of the step of: receiving a write-in/read-out request for a selected endpoint; conducting the requested write-in/read-out operation by means of a buffer allocated to the endpoint; updating data storage status information of the buffer; and allocating a write-in/read-out buffer to the selected endpoint, for the write-in/read-out operation, in response to the data storage status information.

In this exemplary embodiment, allocating the write-in/read-out buffer is comprised of allocating a buffer including valid data to the read-out buffer, in response to the data storage status information and allocating and write-in/read-out buffer is comprised of allocating an empty one of the buffers to the write-in buffer in response to the data storage status information.

In this exemplary embodiment, the write-in buffer is allocated to make each endpoint receive more than one data.

In this exemplary embodiment, the method is further comprised of storing a result of the allocation with the write-in/read-out buffer and the allocation result of the write-in/read-out buffer is stored in one of the mapping table and the pointer forms.

In this exemplary embodiment, the allocation result of the write-in/read-out buffer includes mapping information for logical and physical addresses of the allocated write-in/read-out buffer and the write-in/read-out operation is carried out with data in a unit equal to or smaller than the maximum packet size.

In this exemplary embodiment, the buffer is a first-in/first-out (FIFO) memory.

A further understanding of the nature and advantages of the exemplary embodiments of the present invention may be realized by reference to the remaining portions of the specification and the attached drawings.

### BRIEF DESCRIPTION OF THE DRAWINGS

Exemplary embodiments of the present invention will be understood in more detail from the following descriptions taken in conjunction with the attached drawings, in which:

FIG. 1 is a block diagram illustrating the overall structure of a USB system in accordance with an exemplary embodiment of the invention;

FIG. 2 is a block diagram illustrating the overall structure of a USB system in accordance with an exemplary embodiment of the invention;

FIG. 2 is a diagram showing a configuration of a FIFO memory block and a feature of allocation with FIFO memories respective to endpoints according to an exemplary embodiment of the present invention;

FIG. 3 is a diagram illustrating an operation of the FIFO controller shown in FIG. 1;

FIGS. 4 and 5 are flow charts showing embodiments of endpoint control method for transceiving data along a ‘OUT’ direction; and

FIGS. 6, 7A and 7B are flow charts showing exemplary embodiments of an endpoint control method for transceiving data along an ‘IN’ direction.

### DETAILED DESCRIPTION OF EXEMPLARY EMBODIMENTS

Exemplary embodiments of the present invention will be described below in more detail with reference to the accompanying drawings. The invention may, however, be embodied in different forms and should not be construed as limited to the exemplary embodiments set forth herein. Rather, these exemplary embodiments are provided so that this disclosure will be thorough and complete, and will fully convey the scope of the present invention to those skilled in the art.

An advanced endpoint control apparatus provided by exemplary embodiments of the present invention dynamically allocates more FIFO memories thereto in accordance with the use conditions of the FIFO memories assigned to endpoints at a first time. Thereby, it minimizes a response for abnormal data transmission, that is, negative response or NAK responses and hence effectively improves the efficiency of transceiving data in a USB system.

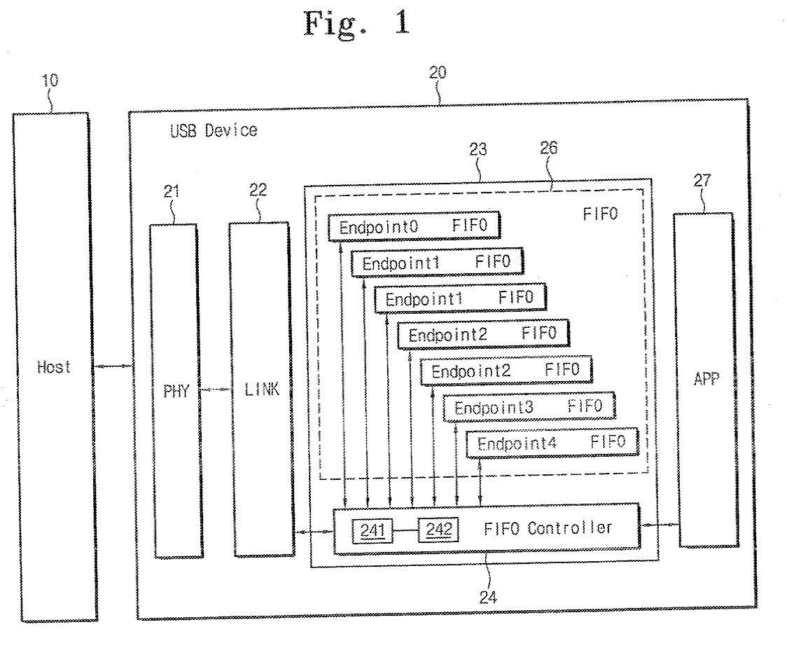

FIG. 1 is a block diagram illustrating the overall structure of a USB system in accordance with an exemplary embodiment of the present invention.

Referring to FIG. 1, the USB system is composed of a host 10 and a USB device 20 connected with the host 10. The USB device 20 according to the invention is comprised of a physical layer (PHY) block 21, a link block 22, an endpoint control block 23, and an application block 27.

The PHY block 21 functions to physically link the USB device with the host 10. The link block 22 controls substantially valid digital data through processing data transferred from the PHY block 21, or transforms digital data into transmission data to be sent into the PHY block 21. The PHY block 21 and the link block 22 may be independently constructed in different chips, or may be integrated in a single link chip with a control function merged thereto. The application block 27 is prepared to conduct a function provided by the USB device, including a control circuit, such as a micro controller or central processor unit (CPU).

The endpoint control block 23 is coupled between the link block 22 and the application block 27. The endpoint control block 23 includes a FIFO memory block 26 and a FIFO controller 24.

The FIFO memory block 26 includes one or more FIFO memories corresponding to a plurality of the endpoints. Each FIFO memory may be formed of a primary storage unit, such as a static random access memory (SRAM) or a flip-flop, or a secondary storage unit, such as a hard disk (HDD) or a dynamic random access memory (DRAM). Because the FIFO memory is equipped with two ports, it is permissible to read out data from the FIFO memory and to write data in the FIFO memory at the same time. By the characteristic of USB, a data transceiving operation between the FIFO memory block 26 and the application block 27 can be carried out independently of a data transceiving operation between the FIFO memory block 26 and the link block 22.

A logical organization of the USB device 20 may be considered as an aggregate of endpoints. The endpoints have their own identification numbers, differentiated by combinations with device addresses. According to the characteristics of the endpoints, transmission patterns between the host 10 and the USB device 20 are determined. The characteristics of the endpoints are recorded in a descriptor. The descriptor also has frequency of bus access, latency, bandwidth, endpoint numbers, the maximum packet size, and so on. The USB device 20 basically includes Endpoint-0 that is used for initialization. Endpoint-0 is established with configuration, status, and control information of bus access, for the USB device 20. A full-speed USB device is permitted to have 16 endpoints, at maximum, each for input and output sides thereof, within a restricted range of protocol, while a low-speed USB device may have two endpoints in addition to Endpoint-0.

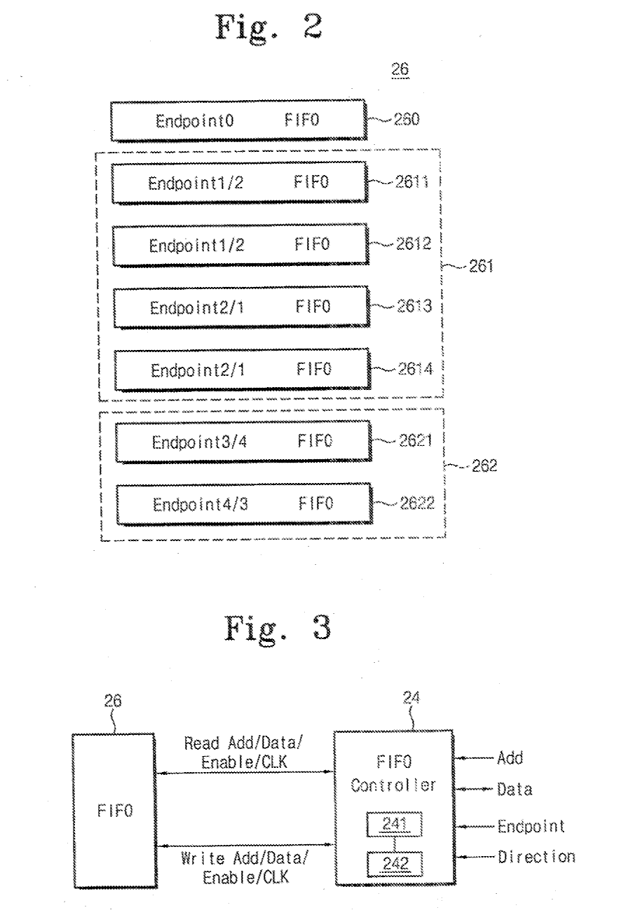

FIG. 2 is a diagram showing a configuration of the FIFO memory block 26 and a feature of allocation with the FIFO memories respective to endpoints according to an exemplary embodiment the present invention.

Referring to FIGS. 1 and 2, in the FIFO memory block 26, one FIFO memory is allocated for Endpoint-0, whereas two FIFO memories may be allocated to Endpoint1 and Endpoint2, while one FIFO memory may be allocated to Endpoint-3 and Endpoint-4.

As illustrated in FIG. 2, the FIFO memory block 26 is divided into a FIFO memory 260 for Endpoint-0, a first FIFO group 261, and a second FIFO group 262. The first FIFO group 261 acts as a FIFO memory group provided for endpoints where a large quantity of data is transceived as in a mobile disk. The first FIFO group 261 may be comprised of two pairs of FIFO memories, 2611 and 2612, and 2613 and 2614, for Endpoint1 and Endpoint 2.

For instance, the two FIFO memories, 2611 and 2612, assigned to Endpoint1 are allocated to data transmission in the IN direction. One of the FIFO memories 2611 and 2612, which does not have valid data, is assigned to a write-in FIFO written by the application block 27 during the data transmission in the IN direction. The other one of the FIFO memories 2611 and 2612, having valid data, is assigned to a read-out FIFO read by the host 10 during the data transmission in the IN direction. On the other hand, the two FIFO memories, 2613 and 2614, assigned to Endpoint2 are allocated to data transmission in the OUT direction. One of the FIFO memories 2613 and 2614, which does not have valid data, is assigned to a write-in FIFO written by the host 10 during the data transmission in the OUT direction. The other one of the FIFO memories 2613 and 2614, having valid data, is assigned to a read-out FIFO read by the application block 27 during the data transmission in the OUT direction. It should be noted that these assignments with the FIFO memories in the directions of data transmission are just an initial establishment for general reading and writing operations, but are not restrictive hereto in usage. As will be detailed hereinbelow, the four FIFO memories 2611˜2614 belonging to the first FIFO group 261 are dynamically allocated to the plural endpoints, that is, Endpoint1 and Endpoint 2. Namely, the total number of FIFO memories assigned to the endpoint is adjusted in accordance with a status of full or empty in a FIFO memory preliminarily assigned to the endpoint requested for writing or reading.

The four FIFO memories 2611˜2614 included in the first FIFO group 261 are the maximum packet size and are all the same. For instance, the FIFO memories 2611˜2614 are permitted to be formed in the maximum packet size of 256 Bytes, being allocated respectively to entries each with 256 Bytes. The FIFO memories 2611˜2614 may be managed in the unit of the maximum packet size, or divisionally regulated in units of plural data sectors smaller than the maximum packet size. For this management, each FIFO memory may have a single memory filed physically, or may be segmented into pluralities of memory sectors.

FIG. 2, while the FIFO memories 2611 and 2612, labeled as ‘Endpoint1/2 FIFO’, are allocated to the transaction for Endpoint1 at the first time, they are also used for Endpoint2. Furthermore, while the FIFO memories 2613 and 2614, labeled as ‘Endpoint2/1 FIFO’, are allocated to the transaction for Endpoint2 at the first time, they are also used for Endpoint1.

For instance, if the FIFO memories 2611 and 2612, which are assigned to Endpoint1, are all being in use, the FIFO controller 24 allocates as an additional FIFO memory the FIFO memories 2613 and 2614 that are conditioned in an empty state, in response to a status information of full/empty. This additional allocation of FIFO memory is preliminarily carried out by the FIFO controller 24 before a request for write-in/read-out to Endpoint1 is generated. Thus, when there is a request for a write-in/read-out operation to Endpoint1, the write-in/read-out operation promptly begins with the additional FIFO memory. In this case, whereas the FIFO memories 2613 and 2614 are physically arranged for Endpoint2, they are logically used for Endpoint1. The FIFO controller 24 stores such mapping information of the FIFO memories into the mapping information storage unit 242. The mapping information storage unit 242 stores the mapping information about endpoints, that is, information of the logical endpoints corresponding to addresses input from the application block 27, and endpoints, that is, information of the physical endpoint containing practical data.

As is well known, the USB is a device of a communication protocol for conducting serial communication. Therefore, it is permissible to conduct a write-in/read-out operation just once to one endpoint. An exemplary embodiment of the present invention enables the FIFO memory of some endpoint, which is not used at present, to be allocated to another endpoint by utilizing the inherent characteristic of the USB. According to this mapping feature, it is possible to dynamically store write-in/read-out data with each endpoint without increasing a size of the FIFO memory. As a result, it remarkably reduces the number of negative responses, that is, NAK responses, due to insufficient capacity of the FIFO memory assigned to the endpoint, thereby minimizing degradation of operation speed in transferring data therein.

The second FIFO group 262 is provided to conduct transceiving operations for small-quantity data like an ASDL modem or an MP3 player. The second FIFO group 262 includes a FIFO memory 2621 assigned to Endpoint3, and a FIFO memory 2622 assigned to Endpoint4. Nevertheless, this mapping pattern is just an initial arrangement, and is not restrictive hereto. More specifically, the two FIFO memories 2621 and 2622 of the second FIFO group 262 may be flexibly allocated to the Endpoint3 and the Endpoint4 just like the first FIFO group 261. The two FIFO memories 2621˜2622 included in the second FIFO group 262 are the maximum packet size and are the same as each other. For instance, the FIFO memories 2621˜2622 are permitted to be formed in the maximum packet size of 128 Bytes, being allocated respective to entries each with 128 Bytes. The maximum packet size is variable in accordance with an amount of data transmission and the ability of data management by the FIFO controller 24. Furthermore, the FIFO memories 2621˜2622 may be managed in the unit of the maximum packet size, or may be divisionally regulated in units of plural data sectors smaller than the maximum packet size. For this management, each FIFO memory may have a signal memory field physically, or may be segmented into pluralities of memory sectors.

In FIG. 2, while the FIFO memory 2621, labeled as ‘Endpoint3/4 FIFO’, is allocated to a transaction for Endpoint3 at the first item, it is also to be used for Endpoint4. Furthermore, while the FIFO memory 2622, labeled as ‘Endpoint4/3 FIFO’, is allocated to a transaction for Endpoint 4 at the first time, it is a also used for Endpoint3. This allocation scheme with the FIFO memories 2621 and 2622 of the second FIFO group 262 to the endpoints is substantially the same as that for the FIFO memories 2611˜2614 of the first FIFO group 261, but with different target FIFO memories.

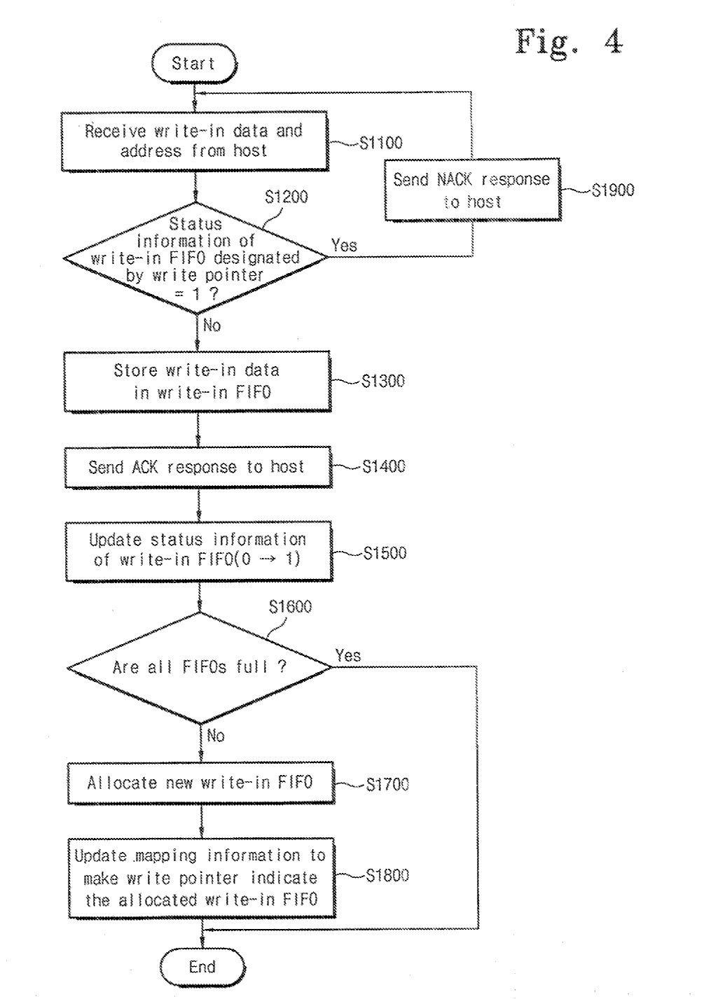

FIG. 3 is a diagram illustrating an operation of the FIFO controller 24 shown in FIG. 1. Referring to FIGS. 1 and 3, and the FIFO controller 24 monitors data storage conditions of the FIFO memory block 26 and controls data write-in/read-out operations to the FIFO memory block 26. The FIFO controller 24 is comprised of a status information storage unit 241 and a mapping information storage unit 242.

The status information storage unit 241 stores information indicating whether the FIFO memories of the FIFO memory block 26 are conditioned in valid states or stores status information about being full or empty in the FIFO memories. For this function, the status information storage unit 24 may be formed of a status transfer register informing on the number of data stored each in the FIFO memories. The mapping information storage unit 242 stores mapping information about an endpoint, that is, a logical endpoint, corresponding to an input address and an endpoint, that is, a physical endpoint, having practical data. The mapping information storage unit 242 is able to contain further information about the transmission direction in addition to the mapping information. The mapping information stored in the mapping information storage unit 242 may be retained in the form of a table or pointers. Structural features of the mapping information storage unit 242 may be variable and modifiable by those skilled in this art.

When there is a request to write-in/read-out from the link block 22 or the application block 27, the FIFO controller 24 transfers to the FIFO memory 26 a write-in/read-out address Write Add/Read Add, data, an enable signal, and a clock signal CLK in response to an address ADD, endpoint information, and transfer direction information. More specifically, the FIFO controller 24 preliminarily allocates the endpoint of the FIFO memory conditioned in an empty state, that is, a condition capable of storing data on the basis of information stored in the mapping information storage unit 242. During this time, each endpoint is assigned with the FIFO memory to further receive more data, and its logical address, that is, an address for which a write-in or read-out operation is requested from the link block 22 or the application block 27, may not agree with its physical address, which is an address where practical data is written in or read out. The FIFO controller 24 determines whether data to be stored is write-in or read-out data when there is a write-in/read-out request from the link block 22 or the application block 27 and stores the data in its corresponding FIFO memory. In allocating the FIFO memories to each entry by this exemplary embodiment of the present invention, the system may be configured to adjust the number of the FIFO memories in a permissible range without being limited to a fixed value. With reference to FIG. 3 and Table 1, hereinafter an operation of the FIFO controller 24 will be described.

TABLE 1

| | Valid data (7 | | | FIFO |
|---|---|---|---|---|
| Endpoint # | bits) | Read pointer | Write pointer | direction |
| Endpoint 0 | 0000000 | A | A | Control IN |
| Endpoint 1 | 0001100 | D | B | OUT |
| Endpoint 2 | 0000000 | C | C | IN |
| Endpoint 3 | 0000010 | F | E | OUT |

Table 1 above includes information, that is, information about the condition of full/empty representing states of validation for the FIFO memories, and mapping information about logical and physical endpoints. The information representing the validation of the FIFO memories is stored in the status information storage unit 241, and the information of the logical and physical endpoints is stored in the mapping information storage unit 242.

In Table 1, Endpoint# means an identification number of the endpoint, 7-bit valid data denotes whether data are present in the FIFO memories, this is, the full/empty states for the FIFO memories. In the 7-bit valid data, the bits arranged from the MSB correspond with the physical addresses of the FIFO memories, that is, A, B, C, D, E, F, and G. For instance, when a certain endpoint uses a FIFO memory having a physical address D and the FIFO memory stores valid data, a valid data bit corresponding to the physical address D is set on ‘1’. Then, a valid data bit of the FIFO memory corresponding to a physical address, which is not being used or which does not store valid data even through it is being used, is set on ‘0’. In Table 1, Endpoint0 corresponding to the valid data ‘0000000’ means that Endpoint0 does not use any of the FIFO memories. Endpoint1 corresponding to the valid data ‘0001100’ means that Endpoint1 uses the FIFO memories storing valid data with physical addresses D and E. In Table 1, three are three ‘1’s (two for Endpoint1 and one for Endpoint3) over all items of the valid data. This means that, among seven FIFO memories, three FIFO memories are conditioned in full states while the rest four FIFO memories are conditioned in empty FIFO memories.

In Table 1, the items labeled with the read pointer indicate the physical addresses of the FIFO memories from which data are read out in response to read-out requests generated from the link block 22 or the application block 27. The items labeled with the write pointer indicate the physical addresses of the FIFO memories from which data are read out in response to write-in requests generated from the link block 22 or the application block 27. In Table 1, the items labeled FIFO direction represent directions of data transmission in transaction. The direction ‘IN’ means data transmission from the USB device 20 toward the host 10, while the direction ‘OUT’ means data transmission from the host 10 toward the USB device 20. During data transmission in the ‘IN’ direction, a write-in operation is carried out in the application block 27 and a read-out operation is carried out in the link block 22. Otherwise, during the ‘OUT’ direction, the write-in operation is carried out in the link block 22 and the read-out operation is carried out in the application block 27.

In Table 1, if there is generated a data write-in request for writing data into Endpoint1 form the host 10, write-in data is stored in the FIFO memory, that is, in the address B, designated by the write pointer. During this, status information of data storage in the FIFO memory, that is, in the address B, is updated to be ‘1’ from ‘0’. The updated data-storage status information is stored in the status information storage unit 241. After storing data into the preset wire-in FIFO memory, that is, the address B by read pointer, the FIFO controller 24 selects a new one, for allocation, among the FIFO memories conditioned in the empty sates. The write pointer is updated with a new value so as to designate the newly allocated FIFO memory. The information of allocation for the updated FIFO memory, that is, the mapping information, is saved in the mapping information storage unit 242. The entry values correspondent with Endpoint1 are shown in Table 2 below.

TABLE 2

| | | | Write | FIFO |
|---|---|---|---|---|
| Endpoint # | Valid data (7 bits) | Read pointer | pointer | direction |
| Endpoint 1 | 0001100 -> | D | B -> G | OUT |
| | 0101100 | | | |

According to the establishment feature for the write-in operation and the write pointer, each endpoint may be set to receive more data in addition to the data preliminary stored therein. But, when all the FIFO memories are conditioned in the full states, it is impossible to allocate an additional FIFO memory.

Referring to Table 2, if there is a read-out request of the ‘OUT’ direction, for Endpoint1, from the application block 27, data is read out from the FIFO memory, that is, from the physical address D, designated by the read pointer. The read-out data is transferred to the application block 27 and then the status information for data storage in the FIFO memory, that is, the address D, is updated to ‘0’ from ‘1’. This updated status information of data storage is saved in the status information storage unit 241. After reading data from the preset FIFO memory, that is, from the address D, the FIFO controller 24 is updated to make the read pointer designate a FIFO memory, that is, the address E, storing valid data. Allocation information of the updated FIFO memory, that is, the mapping information, is stored in the mapping information storage unit 242. During this updating, entry values corresponding to Endpoint1 are arranged in Table 3.

TABLE 3

| | | | Write | FIFO |
|---|---|---|---|---|
| Endpoint # | Valid data (7 bits) | Read pointer | pointer | direction |
| Endpoint 2 | 0101100 -> | D -> E | B | OUT |
| | 0100100 | | | |

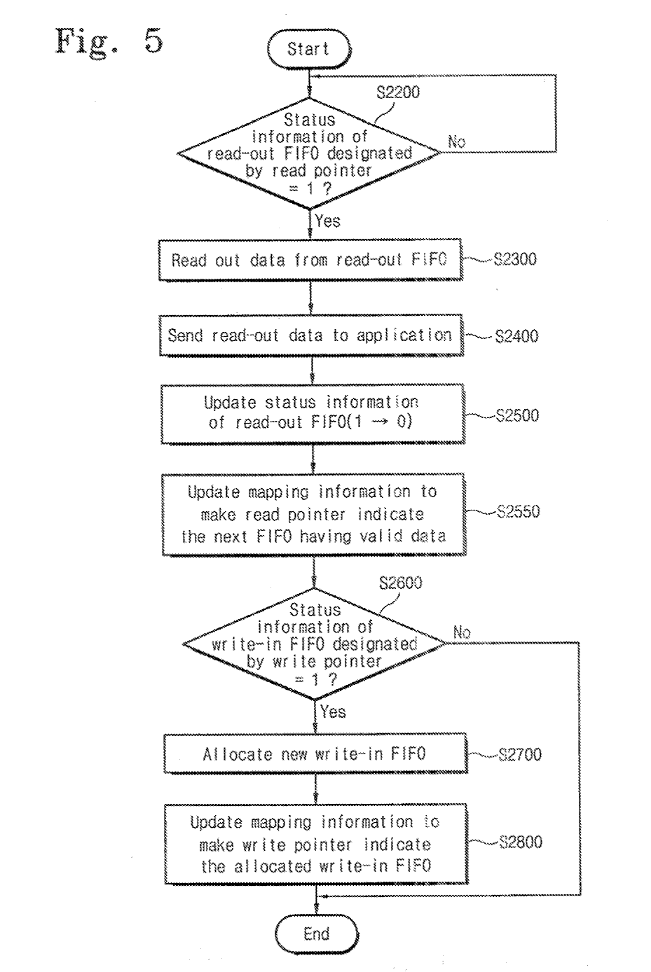

As described below, the FIFO controller 24 according to the exemplary embodiment of the present invention analyzes the write-in/read-out operations of the link block 22 included in USB device 20 and flexibly allocates the FIFO memories for the write-in/read-out operations based on the analyzed result. The FIFO controller 24 also writes write-in/read-out data in the allocated FIFO memory. Such dynamic allocated of the FIFO memory is conducted in real time. The description above relates to the write-in and read-out operations performed during data transmission in the ‘OUT’ direction. While the aforementioned description does not deal with the feature of data transmission in the ‘IN’ direction, the ways of allocating/updating the FIFO memory and writing/reading data are basically the same as those with the ‘OUT’ direction, but differ from the former case in the data transfer direction. Data transcription (transmission+reception) in the ‘OUT’ and ‘IN’ directions will be described in detail with reference to FIGS. 4 through 7.

Meanwhile, the FIFO controller 24 according to the exemplary embodiment of the invention is able to adjust the size of the FIFO memory block assigned to each endpoint. More specifically, the FIFO controller 24 flexibly regulates the mapping operations for the endpoints and FIFO memories in accordance with the whole memory capacity of the FIFO memory block 26, the data size to be divisionally managed, the number of endpoints to be assisted, and a condition whether the FIFO structure is physically formed of a single memory or a plurality of memories.

As an example, referring to FIG. 2, if the maximum packet size of the FIFO memories 2611˜2614 included in the first FIFO group 261 is 256 Bytes, the FIFO controller 24 is able to allocate the FIFO memories to a buffer for the IN/OUT operation, that is, the data write-in/read-out operation, of each endpoint. During this operation, the data stored in the newly allocated FIFO memory is controlled in units of 256 Bytes.

Additionally, each FIFO memory may be controlled with a unit of plural data bits within the range of the maximum packet size. For instance, in each FIFO memory string the 256 Bytes as a whole is divided into two memory fields, each of which stores 128Byte data. When one of the FIFO memories 2611 and 2612, which is being set for Endpoint1, is assigned to Endpoint2, the FIFO controlled 24 is able to make the 128Byte data stored sequentially in the two memory fields disposed in the newly allocated FIFO memories 2611 or 2612. Through this configuration, it is possible to efficiently control the mapping operations with the endpoints and FIFO memories, without consuming the FIFO memories, according to a size of data written in or read from the FIFO memory. Furthermore, although the above description describes the case in which the endpoints and the FIFO memories are allocated thereto within the FIFO memories belonging to the first FIFO group, 261, it is just an exemplary embodiment for contributing to understanding this exemplary embodiment of the represent invention. In the case of setting the data size of each FIFO memory to be smaller, it may be possible to operate the allocation with FIFO memories between the FIFO memories 2611˜2614 of the first FIFO group 261 and the FIFO memories 2621 and 2622 of the second FIFO group 262.

Hereinafter is a more detailed description of the method for controlling the endpoints in data transmission directions of the ‘IN’ and ‘OUT’ modes.

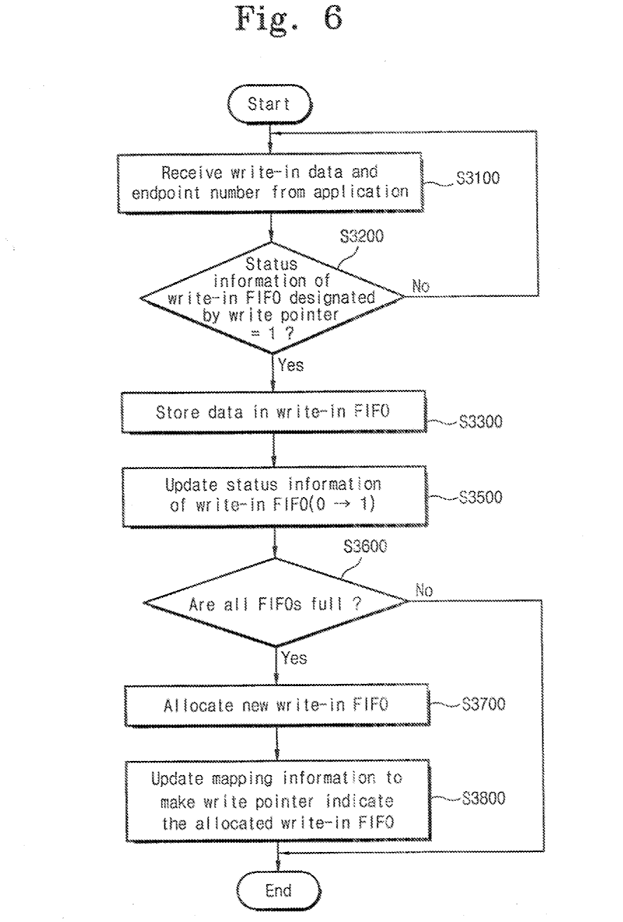

FIGS. 4 and 5 are flow charts showing exemplary embodiments of an endpoint control method for transceiving data along the ‘OUT’ direction. FIFO. 4 shows ways of writing data, which has been input from the host 10 of FIG. 1 during the data transmission along the ‘OUT’ direction, into a write-in FIFO memory of a selected endpoint, and allocating a new write-in FIFO memory.

Referring to FIGS. 1, 2, and 4, the FIFO controller 24 receives the write-in data D and the address ADD, which are to be used in data transcription of the ‘OUT’ direction, from the host 10 (step S1100). The data D and the address ADD are provided to the FIFO controller 24 from the host 10 by way of the link block 22. The FIFO controller 24 finds whether the data storage status information of the FIFO memory, which is designated by the write pointer of the endpoint in which the data D is to be stored, is set on ‘1’ (step S1200). The status information of ‘1’ means that it is impossible to further store the data, which has been input in the step of S1100, in the write-in FIFO memory of the corresponding endpoint because it is full of data. As detailed hereinafter, the exemplary embodiment of the present invention is configured to set the FIFO memory to be able to receive more data for each endpoint. Thus, a condition that the write-in FIFO memory designated by the write pointer cannot receive further data means that all the FIFO memories are already full of data.

From the determination in step S1200, if the data storage status information of the write-in FIFO memory is set on ‘1’, that is, if all the FIFO memories are full of data, it generates a negative response (NAK response) to the host 10 (step S1900). Otherwise, from the determination in step S1200, if the data storage status information of the write-in FIFO memory is out of ‘1’, that is, it is set on ‘0’, the write-in data D is stored in the write-in FIFO memory (step S1300). Then, it generates an ACK response to the host 10 (step S1400). After storing data in the write-in FIFO memory, status information of the write-in FIFO memory is updated to ‘1’ from ‘0’ (step S1500). The updated status information of the FIFO memory is stored in the status information storage unit 241.

Continuing, it is then determined whether all the FIFO memories are full of data (step S1600). From the determination in step S1600, if all of the FIFO memories are full of data, a new write-in FIFO memory is additionally allocated (step S1700). Then, the mapping information is updated to make the write pointer indicate the new write-in FIFO memory (step S1800). Allocation information for the updated FIFO memory, that is, the mapping information, is saved in the mapping information storage unit 242. From the determination in step 1600, if all the FIFO memories are already full of data, and a new write-in FIFO memory cannot be additionally allocated, then the procedure is terminated.

FIG. 5 shows ways of transmitting data, which has been read out from a write-in FIFO memory of an endpoint during the data transmission along the ‘OUT’ direction, to the application block 27 of FIG. 1, and allocating a new write-in FIFO memory.

Referring to FIG. 5, the application block 27 first finds whether data is present in an endpoint to be read. For this operation, the FIFO controller 24 determines whether data storage status information of a read-out FIFO memory designated by the read pointer of a corresponding endpoint is set on ‘1’ (step S2200). This determination result is transferred to the application block 27. Here, the status information of ‘1’ means that data is being stored in the corresponding FIFO memory.

From the determination result IN step S2200, if the data storage status information of the read-out FIFO memory is set on ‘1’, that is, if there is data to be read, the data D is read out from the corresponding read-out FIFO memory (step S2300). The read-out data is transferred to the application block 27 (step S2400). Then, the status information of the read-out FIFO memory is updated to ‘0’ from ‘1’ (step S2500). The updated status information of the FIFO memory is saved in the status information storage unit 241.

Subsequently, the mapping information is updated to make the read pointer designate the next FIFO memory that contains valid data (step S2550). The updated allocation information of the FIFO memory, that is, the mapping information, is saved in the mapping information storage unit 242.

In the endpoint control scheme according to the exemplary embodiment of the present invention, status information of the rite pointer is checked in order to enable the FIFO memory to make each endpoint receive more data. More specifically, it is determined that the data storage status information of a write-in FIFO memory designated by the write pointer is set on ‘1’ (step S2600). From the determination in step S2600, the data storage status information of the write-in FIFO memory is set on ‘1’, and a new write-in FIFO memory is allocated thereto (step S2700). This condition that the data storage status information of the write-in FIFO memory is staying on ‘1’ means that all the FIFO memories have been already conditioned full of data at the step S1600 of FIG. 4. In the exemplary embodiment of the present invention, after completing the read-out operation in steps S2300 through S2500, at least one of the FIFO memories is conditioned in the empty state. Thus, it is permissible to additionally allocate a new write-in FIFO memory thereto.

After allocating the new write-in FIFO memory in step S2700, the mapping information is updated to make the write pointer designate the new write-in FIFO memory (step S2800). The updated allocation information of the FIFO memory, that is, the mapping information, is saved in the mapping information storage unit 242.

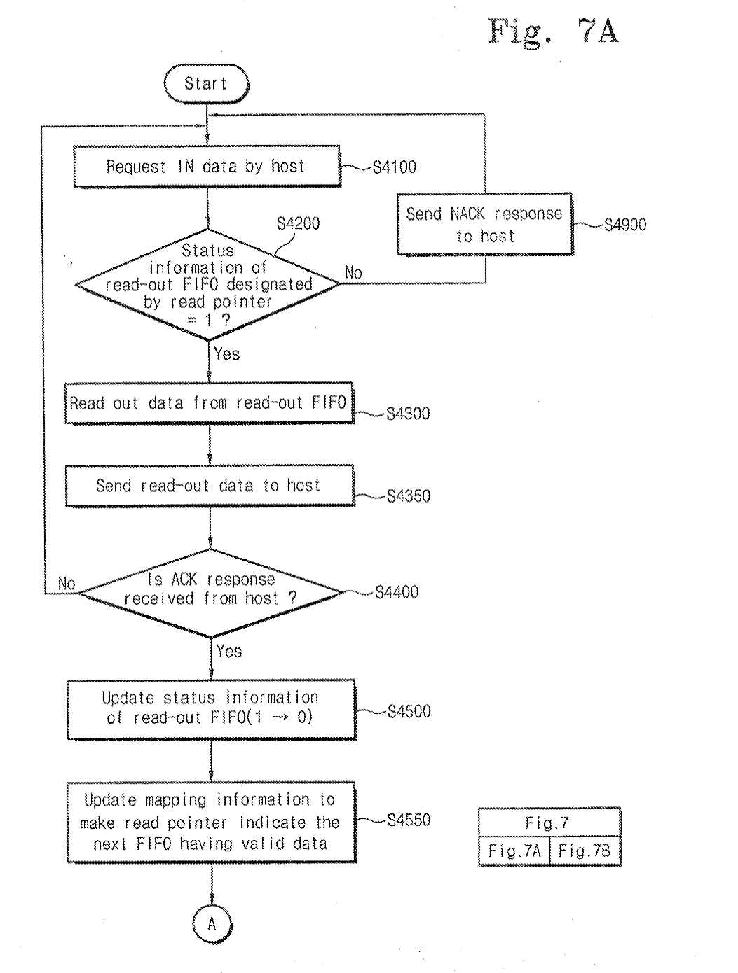

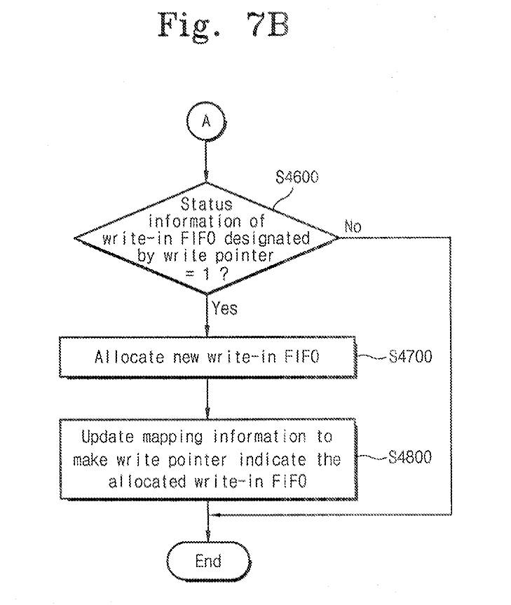

FIGS. 6, 7A and 7B are flow charts showing exemplary embodiments of an endpoint control method for transceiving the data along the ‘IN’ direction. FIG. 6 shows ways of storing data, which has been transferred from the application block 27 during the data transmission along the ‘IN’ direction, into a write-in FIFO memory of a selected endpoint, and allocating a new write-in FIFO memory.

Referring to FIGS. 1, 3, and 6, the FIFO controller 24 receives the write-in data D, which is to be used in data transcription of the ‘IN’ direction, from the application block 27, and an endpoint number to be written (step S3100). The FIFO controller 24 finds whether all the FIFO memories assigned to the corresponding endpoint are full of data. For this operation, the FIFO controller 24 determines whether the data storage status information of the FIFO memory, which is designated by the write pointer of the corresponding endpoint, is set on ‘1’ (step S3200). The status information of ‘1’ in the write-in FIFO memory means that the corresponding write-in FIFO memory already has data, thereby indicating that all the FIFO memories assigned for the corresponding endpoint are already full of data.

From the determination in step S3200, if the data storage status information of the write-in FIFO memory is set on ‘1’, that is, if all the FIFO memories of the corresponding endpoint are full of data, the application block 27 is not permitted to resume a data write-in operation. On the other hand, from the determination in step S3200, if the data storage status information of the write-in FIFO memory is not ‘1’, that is, it is set on ‘0’, the write-in data D is stored in the corresponding write-in FIFO memory (step S3300). Then, status information of the write-in FIFO memory is updated to ‘1’ from ‘0’ (step S3500). The updated status information of the FIFO memory is stored in the status information storage unit 241.

Continuing the method, it is determined whether all the FIFO memories are full of data (step S3600). From the determination in step S3600, if all of the FIFO memories are full of data, a new write-in FIFO memory is additionally allocated (step S3700). Then, the mapping information is updated to make the write pointer indicate the new write-in FIFO memory (step S3800). Allocation information for the updated FIFO memory, that is, the mapping information, is saved in the mapping information storage unit 242. Meanwhile, from the determination in step 3600, if all the FIFO memories are full of data, a new write-in FIFO memory cannot be additionally allocated and the procedure is terminated.

FIGS. 7A and 7B show exemplary methods of transmitting data, which has been read out from a write-in FIFO memory of an endpoint during the data transmission along the ‘OUT’ direction, to the host 10, and allocating a new write-in FIFO memory.

Referring to FIGS. 7A and 7B, the host 10 generates in IN token to request data, that is, IN data, which is to be read, from a corresponding endpoint (step S4100). The FIFO controller 24 determines whether data storage status information of a read-out FIFO memory designated by the read pointer of a corresponding endpoint is set on ‘1’ (step S4200). The status information of ‘1’ means that data is being stored in the corresponding FIFO memory.

From the determination in step S4200, if the data storage status information of the read-out FIFO memory is not set on ‘1’, that is, there is no data to be red, a negative response (NAK response) is generated to the host 10 (step S4900). From the determination in step S4200, if the data storage status information of the read-out FIFO memory is staying on ‘1’, that is, there is data to be read, the data D is read out from the corresponding read-out FIFO memory (step S4300). The read data is transferred to the host 10 by way of the link block 22.

Subsequently, it is determined whether an ACK response has been generated from the host 10 (step S4400). From the determination in step S4400, if the ACK response has not been generated from the host 10, the procedure returns to the beginning. From the determination in step S4400, if the ACK response has been generated from the host 10, the status information of the read-out FIFO memory is updated to ‘0’ from ‘1’ (step S4500). The updated status information of the FIFO memory is saved in the status information storage unit 241. Then, the mapping information is updated to make the read pointer designate the next FIFO memory that contains valid data (step S4550). The updated allocation information of the FIFO memory, that is, the mapping information, is saved in the mapping information storage unit 242.

Meanwhile, in the endpoint control scheme according to the exemplary embodiment of the present invention, status information of the write pointer is checking in order to enable the FIFO memory to make each endpoint receive more data. For this function, it is determined that data storage status information of a write-in FIFO memory designated by the write pointer is set on ‘1’ (step S4600). From the determination by the step S4600, the data storage status information of the write-in FIFO memory is set on ‘1’, a new write-in FIFO memory is additionally allocated thereto (step S4700). This condition that the data storage status information of the write-in FIFO memory is staying on ‘1’ means that all the FIFO memories have been already conditioned to be full of data previously (at the step S3600 of FIG. 4). In the exemplary embodiment of the present invention, after completing the read-out operation in steps S4300 through S4500, at least one of the FIFO memories is conditioned in the empty state. Thus, it is permissible to additionally allocate a new write-in FIFO memory thereto. After allocating the new write-in FIFO memory, the mapping information is updated to make the write pointer designate the new write-in FIFO memory (step S4800). The updated allocation information of the FIFO memory, that is, the mapping information, is saved in the mapping information storage unit 242. In the meantime, from the determination result in step 4600, if all the FIFO memories are full of data, a new write-in FIFO memory cannot be further allocated thereto and the procedure is terminated.

As described above, in the endpoint control method according to the exemplary embodiment of the present invention, it is possible to dynamically or flexibly allocate or assign the FIFO memory of each endpoint to a corresponding transaction without increasing a system clock frequency or enlarging a capacity of the FIFO memory. More specifically, according to an exemplary embodiment of the present invention, because the dynamic allocation is carried out in real time, it minimizes the generation of the negative response, that is, NAK response, and improves the efficiency of data transcription in the USB system.

The above-disclosed subject matter is to be considered illustrative, and not restrictive, and the appended claims are intended to cover all such modifications, enhancements, and other embodiments, which fall within the true spirit and scope of the present invention. Thus, to the maximum extend allowed by law, the scope of the present invention is to be determined by the broadest permissible interpretation of the following claims and their equivalents, and shall not be restricted or limited by the foregoing detailed description.

What is claimed is:

1. An endpoint control apparatus for a device communicating between a host and a plurality of endpoints by way of a universal serial bus, the apparatus comprising:
pluralities of buffers corresponding to the plurality of endpoints;
a first storage unit having data storage status information of the buffers;
a controller allocating an empty one of the plurality of buffers to a selected one of the endpoints in response to the data storage status information; and
a second storage unit having a result of the buffer allocation by the controller.

2. The endpoint control apparatus as set forth in claim 1, wherein the buffers are first-in/first-out (FIFO) memories.

3. The endpoint control apparatus as set forth in claim 1, wherein the data storage status information represents whether each buffer is empty.

4. The endpoint control apparatus as set forth in claim 1, wherein the first storage unit includes a status transfer register informing of the number of data stored in each buffer.

5. The endpoint control apparatus as set forth in claim 1, wherein the second storage unit has logical and physical addresses of the buffer allocated to the selected endpoint.

6. The endpoint control apparatus as set forth in claim 1, wherein the buffer allocation result is stored in one of a mapping table and pointer forms.

7. The endpoint control apparatus as set forth in claim 1, wherein the plurality of buffers have the same memory size.

8. The endpoint control apparatus as set forth in claim 1, wherein the plurality of buffers store data in a unit equal to or smaller than a maximum packet size.

9. The endpoint control apparatus as set forth in claim 1, wherein the controller allocates the buffer to make each endpoint receive more data.

10. A method of controlling endpoints for a device communicating between a host and the endpoints by way of a universal serial bus, the method comprising:
receiving a write-in/read-out request for a selected endpoint;
conducting the requested write-in/read-out operation by means of a buffer allocated to the endpoint;
updating data storage status information of the buffer; and allocating a write-in/read-out buffer to the selected endpoint, for the write-in/read-out operation, in response to the data status information.

11. The method as set forth in claim 10, wherein allocating the write-in/read-out buffer is comprised of allocating a buffer including valid data to the read-out buffer, in response to the data storage status information.

12. The method as set forth in claim 10, wherein allocating the write-in/read-out buffer is comprised of allocating an empty buffer to the write-in buffer in response to the data storage status information.

13. The method as set forth in claim 12, wherein the write-in buffer is allocated to make each endpoint receive more data.

14. The method as set forth in claim 10, further comprising: storing a result of the allocation with the write-in/read-out buffer.

15. The method as set forth in claim 14, wherein an allocation result of the write-in/read-out buffer is sorted in one of a mapping table and pointer forms.

16. The method as set forth in claim 14, wherein an allocation result of the write-in/read-out buffer includes mapping information for logical and physical addresses of the allocated write-in/read-out buffer.

17. The method as set forth in claim 10, wherein the write-in/read-out operation is carried out with data in a unit equal to or smaller than a maximum packet size.

18. The method as set forth in claim 10, wherein the buffer is a first-in/first-out (FIFO) memory.
